(19) United States
(12) Patent Application Publication
(10) Pub. No.: US 2025/0182741 A1
(43) Pub. Date: Jun. 5, 2025

(54) Interactive System Rendering Human Speaker Specified Expressions

(71) Applicant: Disney Enterprises, Inc., Burbank, CA (US)

(72) Inventors: Komath Naveen Kumar, Los Angeles, CA (US); James R. Kennedy, Glendale, CA (US)

(21) Appl. No.: 18/526,441

(22) Filed: Dec. 1, 2023

(51) Int. Cl. G10L 13/10; G10L 15/02; G10L 15/18; G10L 15/187; G10L 15/22

(52) U.S. Cl. CPC G10L 13/10; G10L 15/02; G10L 15/1807; G10L 15/187; G10L 15/22

(57) ABSTRACT

A system includes a hardware processor and a memory storing software code and a natural language understanding (NLU) model. The hardware processor executes the software code to receive audio input including speech by a human speaker, produce a text transcription of the audio input, identify, using the NLU model and the text transcription, a segment of interest of the audio input that includes a feature of interest, and analyze one or more audio characteristic(s) of the feature of interest. The software code is further executed to identify, using the text transcription, a text string corresponding to the feature of interest, generate a response to the audio input that includes the text string, and modify the response using the audio characteristic(s) to produce an output response in which the text string is uttered in a characteristic voice of a non-human social agent using a word pronunciation utilized by the human speaker.

### BACKGROUND

One of the characteristic features of human interaction is variety of expression, including variations in the way certain words are pronounced. First names, surnames and place names, for example, may be pronounced differently by different people, or may be pronounced differently under different circumstances. For instance, the place name St. John, as well as the surname St. John in American English, is typically pronounced “Saint John.” However, in British English, when used as a first name or other given name, St. John is typically pronounced “Sinjin.”

In order for a non-human social agent, such as one embodied as an artificial intelligence interactive character, for example, to build rapport with a human interacting with the social agent, it is desirable for the social agent to be able to mirror the pronunciations utilized by the human speaker. However, conventional approaches to interpreting human speech and generating responsive expressions for use by a social agent rely on speech-to-text and text-to-speech transcription techniques that can undesirably produce dissonant results. Consequently, there is a need in the art for a solution enabling a non-human social agent to vary its pronunciation to agree with that of a human speaker with whom the social agent interacts.

### BRIEF DESCRIPTION OF THE DRAWINGS

FIG. 1 shows an exemplary interactive system rendering human speaker specified expressions, according to one implementation;

FIG. 2A shows a more detailed diagram of an input unit suitable for use as a component of the system shown in FIG. 1, according to one implementation;

FIG. 2B shows a more detailed diagram of an output unit suitable for use as a component of the system shown in FIG. 1, according to one implementation;

FIG. 3 shows a diagram of a software code suitable for use by the system shown in FIG. 1, according to one implementation; and

FIG. 4 shows a flowchart presenting an exemplary method for use by a system to render human speaker specified expressions, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

The present application discloses interactive systems and methods rendering human speaker specified expressions that address and overcome the deficiencies in the conventional art by enabling a non-human social agent to vary its form of expression, including prosody and pronunciation, for example, to agree with those of a human speaker with whom the non-human social agent interacts, in real-time with respect to the interaction. Moreover, the present solution for rendering human speaker specified expressions may advantageously be implemented as automated systems and method.

As used in the present application, the terms “automation,” “automated” and “automating” refer to systems and processes that do not require the participation of a human system administrator. Although in some implementations the expressions generated by the systems and methods disclosed herein may be reviewed or even modified by a human editor or system administrator, that human involvement is optional. Thus, the methods described in the present application may be performed under the control of hardware processing components of the disclosed systems.

In addition, as defined in the present application, a non-human social agent (hereinafter “social agent”) refers generally to an artificial intelligence (AI) agent that exhibits behavior and intelligence that can be perceived by a human whom interacts with the social agent as a unique individual with its own personality. Social agents may be implemented as machines or other physical devices, such as robots or toys, or may be virtual entities, such as digital characters presented by animations on a screen. Social agents may speak with their own characteristic voice (e.g., phonation, pitch, loudness, rate, dialect, accent, rhythm, inflection and the like) such that a human observer recognizes the social agent as a unique individual. Social agents may exhibit characteristics of living or historical characters, fictional characters from literature, film and the like, or simply unique individuals that exhibit patterns that are recognizable by humans as a personality.

It is noted that, as defined in the present application, the expression “real-time” refers to a time interval that enables an interaction, such as a dialogue for example, to occur without an unnatural seeming delay between a statement or question by a human speaker and a responsive expression by a social agent. By way of example, “real-time” may refer to a social agent response time of on the order of one hundred milliseconds, or less. It is further noted that the term “non-verbal vocalization” refers to vocalizations that are not language based, such as a grunt, sigh, or laugh to name a few examples, while a “non-vocal sound” refers to a hand clap or other manually generated sound. It is also noted that, as used herein, the term “prosody” has its conventional meaning and refers to the stress, rhythm, and intonation of spoken language.

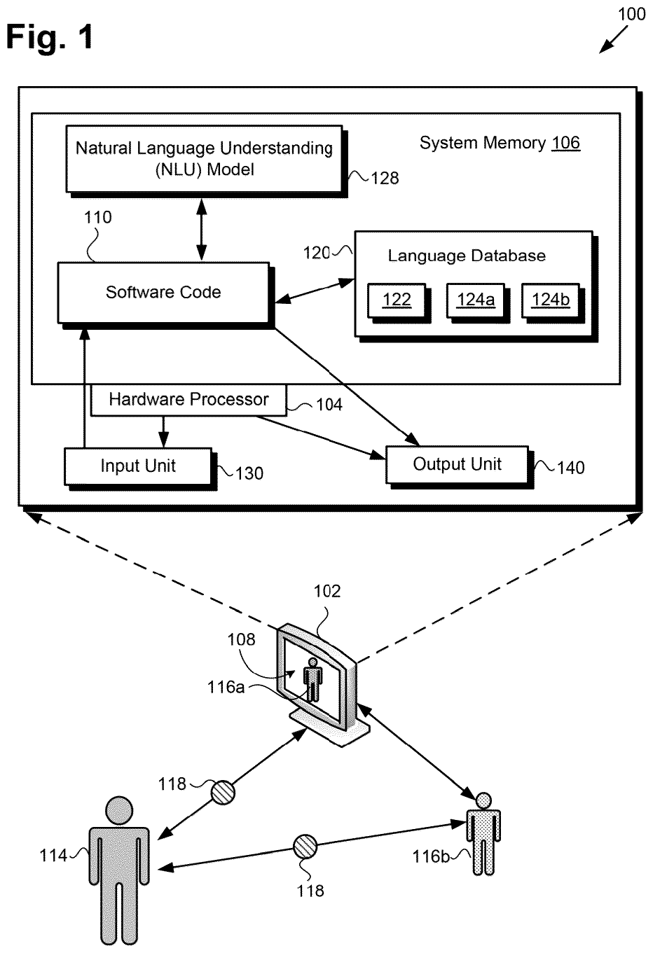

FIG. 1 shows a diagram of system 100 rendering human speaker specified expressions, according to one exemplary implementation. As shown in FIG. 1, system 100 includes computing platform 102 having hardware processor 104, input unit, output unit 140 including display 108, and system memory 106 implemented as a non-transitory storage medium. According to the present exemplary implementation, system memory 106 stores software code 110 and natural language understanding (NLU) model 128 including a machine learning (ML) model, and may optionally further store language database 120 including disapproved list 122 of prohibited words and multiple generic responses 124a and 124b. In addition, FIG. 1 shows social agents 116a and 116b for which responses to audio input 118 from human speaker 114 can be generated using software code 110, executed by hardware processor 104.

It is noted that, as defined in the present application, the expression “ML model” refers to a computational model for making future predictions based on patterns learned from samples of data or “training data.” Various learning algorithms can be used to map correlations between input data and output data. These correlations form the computational model that can be used to make future predictions on new input data. Such a predictive model may include one or more logistic regression models, Bayesian models, or artificial neural networks (NNs), for example. Moreover, a “deep neural network,” in the context of deep learning, may refer to an NN that utilizes multiple hidden layers between input and output layers, which may allow for learning based on features not explicitly defined in raw data. As used in the present application, any feature identified as an NN refers to a deep neural network.

It is further noted that although FIG. 1 depicts social agent 116a as being instantiated as a digital character rendered on display 108, and depicts social agent 116b as a robot, those representations are provided merely by way of example. In other implementations, one or both of social agents 116a and 116b may be instantiated by devices, such as audio speakers, displays, or figurines, or by wall mounted audio speakers or displays, to name a few examples. It is also noted that social agent 116b corresponds in general to social agent 116a and may include any of the features attributed to social agent 116a. Moreover, although not shown in FIG. 1, like computing platform 102, in some implementations social agent 116b may include hardware processor 104, input unit 130, output unit 140, and system memory 106 storing software code 110 and natural language understanding (NLU) model 128, and may optionally further store language database 120 including disapproved list 122 and generic responses 124a and 124b.

Furthermore, although FIG. 1 depicts one human speaker 114 and two social agents 116a and 116b, that representation is merely exemplary. In other implementations, one social agent, two social agents, or more than two social agents may engage in an interaction with one or more human beings corresponding to human speaker 114. It is also noted that although FIG. 1 depicts two generic responses 124a and 124b, language database 120 will typically store tens or hundreds of generic responses.

Although the present application refers to software code 110, optional language database 120, and NLU model 128 as being stored in system memory 106 for conceptual clarity, more generally, system memory 106 may take the form of any computer-readable non-transitory storage medium. The expression “computer-readable non-transitory storage medium,” as defined in the present application, refers to any medium, excluding a carrier wave or other transitory signal that provides instructions to hardware processor 104 of computing platform 102. Thus, a computer-readable non-transitory medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory storage media include, for example, optical discs, RAM, programmable read-only memory (PROM), erasable PROM (EPROM), and FLASH memory.

It is further noted that although FIG. 1 depicts software code 110, optional language database 120, and NLU model 128 as being co-located in system memory 106, that representation is also merely provided as an aid to conceptual clarity. More generally, system 100 may include one or more computing platforms 102, such as computer servers for example, which may be co-located, or may form an interactively linked but distributed system, such as a cloud based system, for instance. As a result, hardware processor 104 and system memory 106 may correspond to distributed processor and memory resources within system 100. Consequently, in some implementations, software code 110, optional language database 120, and NLU model 128 may be stored remotely from one another on the distributed memory resources of system 100.

Computing platform 102 may take the form of a desktop computer, or any other suitable mobile or stationary computing system that implements data processing capabilities sufficient to provide a user interface, and implement the functionality attributed to computing platform 102 herein. For example, in other implementations, computing platform 102 may take the form of a laptop computer, tablet computer, smartphone, or an augmented reality (AR) or virtual reality (VR) device, for example, providing display 108. Display 108 may take the form of a liquid crystal display (LCD), a light-emitting diode (LED) display, an organic light-emitting diode (OLED) display, a quantum dot (QD) display, or any other suitable display screen that performs a physical transformation of signals to light.

It is also noted that although FIG. 1 shows both input unit 130 and output unit 140 as residing on computing platform 102, that representation is merely exemplary as well. In other implementations including an all-audio interface, for example, input unit 130 may be implemented as a microphone, while output unit 140 may take the form of an audio speaker. Moreover, in implementations in which social agent 116b takes the form of a robot or other type of machine, input unit 130 and/or output unit 140 may be integrated with social agent 116b rather than with computing platform 102. In other words, in some implementations, social agent 116b may include one or both of input unit 130 and output unit 140.

Hardware processor 104 may include multiple hardware processing units, such as one or more central processing units, one or more graphics processing units, and one or more tensor processing units, one or more field-programmable gate arrays (FPGAs), custom hardware for machine-learning training or inferencing, and an application programming interface (API) server, for example. By way of definition, as used in the present application, the terms “central processing unit” (CPU), “graphics processing unit” (GPU), and “tensor processing unit” (TPU) have their customary meaning in the art. That is to say, a CPU includes an Arithmetic Logic Unit (ALU) for carrying out the arithmetic and logical operations of computing platform 102, as well as a Control Unit (CU) for retrieving programs, such as software code 110, from system memory 106, while a GPU may be implemented to reduce the processing overhead of the CPU by performing computationally intensive graphics or other processing tasks. A TPU is an application-specific integrated circuit (ASIC) configured specifically for AI applications such as machine learning modeling.

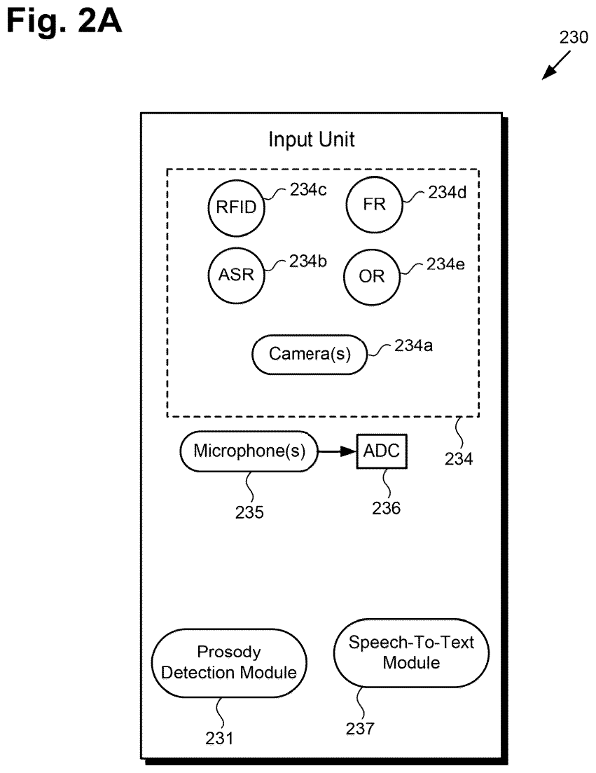

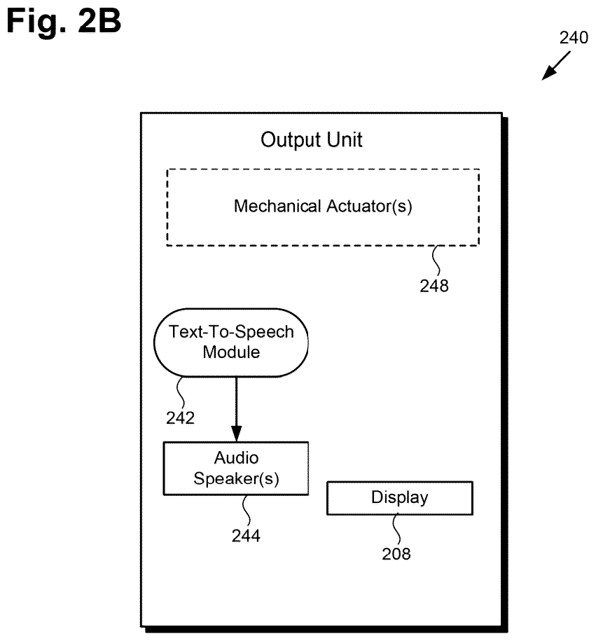

FIG. 2A shows a more detailed diagram of input unit 230 suitable for use as a component of system 100, in FIG. 1, according to one implementation. As shown in FIG. 2A, input unit 230 may include prosody detection module 231, multiple sensors 234, one or more microphones 235 (hereinafter “microphone(s) 235”), analog-to-digital converter (ADC) 236 and speech-to-text (STT) module 237. As further shown in FIG. 2A, sensors 234 of input unit 230 may include one or more cameras 234a (hereinafter “camera(s) 234a”), automatic speech recognition (ASR) sensor 234b, radio-frequency identification (RFID) sensor 234c, facial recognition (FR) sensor 234d and object recognition (OR) sensor 234e. Input unit 230 corresponds in general to input unit 130, in FIG. 1. Thus, input unit 130 may share any of the characteristics attributed to input unit 230 by the present disclosure, and vice versa.

It is noted that the specific sensors shown to be included among sensors 234 of input unit 130/230 are merely exemplary, and in other implementations, sensors 234 of input unit 130/230 may include more, or fewer, sensors than camera(s) 234a, ASR sensor 234b, RFID sensor 234c, FR sensor 234d and OR sensor 234e. Moreover, in some implementations, sensors 234 may include a sensor or sensors other than one or more of camera(s) 234a, ASR sensor 234b, RFID sensor 234c, FR sensor 234d and OR sensor 234e. It is further noted that, when included among sensors 234 of input unit 130/230, camera(s) 234a may include various types of cameras, such as red-green-blue (RGB) still image and video cameras, RGB-D cameras including a depth sensor, and infrared (IR) cameras, for example.

FIG. 2B shows a more detailed diagram of output unit 240 suitable for use as a component of system 100, in FIG. 1, according to one implementation. As shown in FIG. 2B, output unit 240 may include one or more of text-to-speech (TTS) module 242 in combination with one or more audio speakers 244 (hereinafter “audio speaker(s) 244”) and display 208. As further shown in FIG. 2B, in some implementations, output unit 240 may include one or more mechanical actuators 248 (hereinafter “mechanical actuator(s) 248”). It is further noted that, when included as a component or components of output unit 240, mechanical actuator(s) 248 may be used to produce facial expressions by social agent 116b and/or to articulate one or more limbs or joints of social agent 116b. Output unit 240 and display 208 correspond respectively in general to output unit 140 and display 108, in FIG. 1. Thus, output unit 140 and display 108 may share any of the characteristics attributed to output unit 240 and display 208 by the present disclosure, and vice versa.

It is noted that the specific features shown to be included in output unit 140/240 are merely exemplary, and in other implementations, output unit 140/240 may include more, or fewer, features than TTS module 242, audio speaker(s) 244, display 208 and mechanical actuator(s) 248. Moreover, in other implementations, output unit 140/240 may include a feature or features other than one or more of TTS module 242, audio speaker(s) 244, display 208 and mechanical actuator(s) 248. As noted above, display 108/208 of output unit 140/240 may be implemented as an LCD, LED display, OLED display, a QD display, or any other suitable display screen that perform a physical transformation of signals to light,

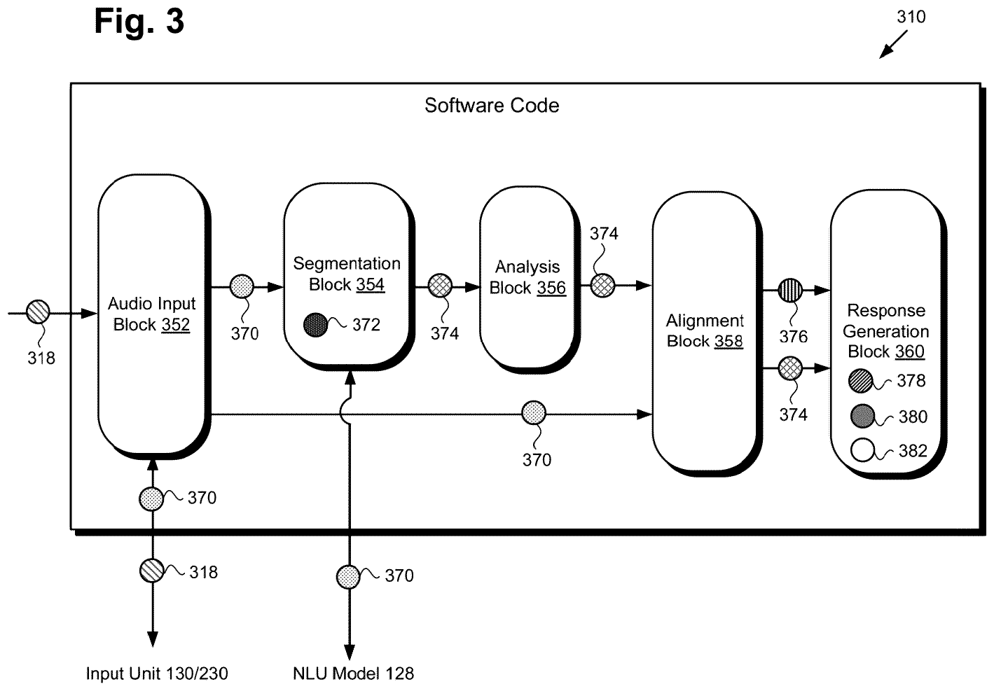

FIG. 3 shows a diagram of software code 310 suitable for use by system 100, shown in FIG. 1, according to one implementation. As shown in FIG. 3, software code 310 is configured to receive audio input. 318, and to generate one or more of response 378, output response 380 and amended output response 382, using audio input block 352, segmentation block. 354, analysis block 356, alignment block 358 and response generation block 360, in combination with input unit 130/230 in FIGS. 1 and 2A, as well as NLU model 128 in FIG. 1. Also shown in FIG. 3 are text transcription 370 of audio input 318, segment of interest 372 of audio input 318, segment of interest 372 including feature of interest 374, and text string 376 corresponding to feature of interest 374.

Software code 310 and audio input 318 correspond respectively in general to software code 110 and audio input 118, in FIG. 1. Consequently, software code 110 and audio input 118 may share any of the characteristics attributed to respective software code 310 and audio input 318 by the present application, and vice versa. That is to say, although not shown in FIG. 1, like software code 310, software code 110 may include features corresponding respectively to audio input block 352, segmentation block 354, analysis block 356, alignment block 358 and response generation block 360.

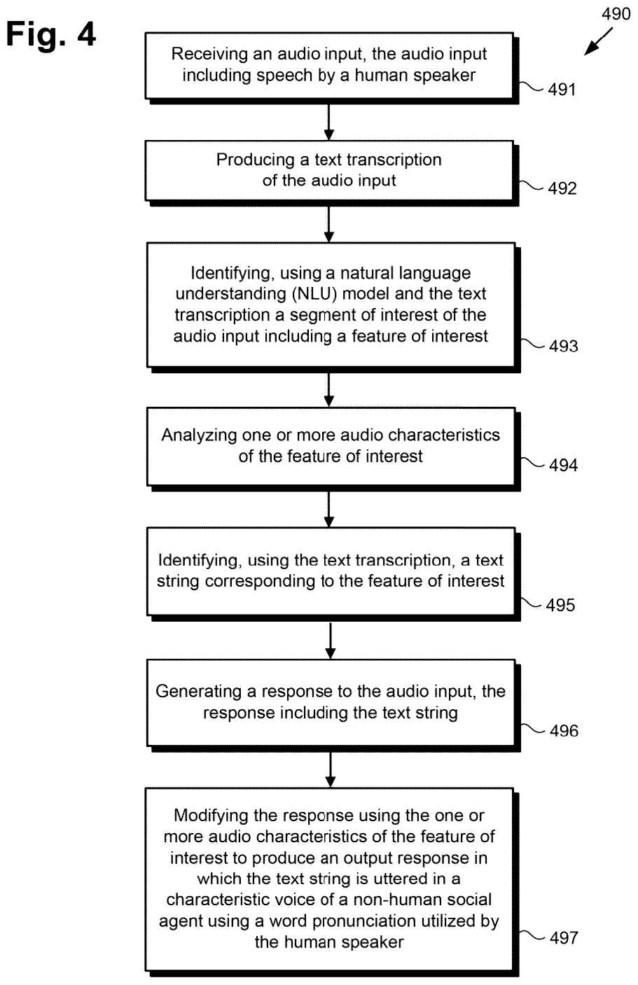

The functionality of software code 110/310 will be further described by reference to FIG. 4. FIG. 4 shows flowchart 490 presenting an exemplary method for use by a system rendering human speaker specified expressions, according to one implementation. With respect to the method outlined in FIG. 4, it is noted that certain details and features have been left out of flowchart 490 in order not to obscure the discussion of the inventive features in the present application.

Referring to FIG. 4, with further reference to FIGS. 1, 2A and 3, flowchart 490 includes receiving audio input 118/318, audio input 118/318 including speech by human speaker 114 (action 491). Audio input 118/318 may include one or more of speech by human speaker 114, i.e., human speech, a non-verbal vocalization by human speaker 114, and a non-vocal sound produced by human speaker 114. As noted above, a non-verbal vocalization refers to vocalizations that are not language based, such as a grunt, sigh, or laugh to name a few examples, while a non-vocal sound refers to a hand clap or other manually generated sound. In addition to sounds produced by human speaker 114, audio input 118/318 may further include ambient sounds, such as background conversations, mechanical sounds, music, and announcements, to name a few examples. Audio input 118/318 may be received in action 491 by software code 110/310, executed by hardware processor 104 of system 100, and using audio input block 352.

Continuing to refer to FIGS. 1, 2A, 3 and 4 in combination, flowchart 490 further includes producing text transcription 370 of audio input 118/318 (action 492). In use cases in which audio input 118/318 includes speech by human speaker 114, text transcription 370 may be a direct transcription of that speech into text. In use cases in which audio input 118/318 includes one or more of a non-verbal vocalization or non-vocal sound, text transcription 370 may include a text description of that vocalization or sound. For example, laughter by human speaker 114 may be described as “laugh,” “laughter,” or “laughing sound” in text transcription 370, while the sound of a hand clap may be described as “clap” or “clapping sound” in text transcription 370. Analogously, ambient sounds may be represented by text descriptions in text transcription 370 of audio input 118/318. Text transcription of audio input 118/318 may be produced in action 492 by software code 110/310, executed by hardware processor 104 of system 100, and using audio input block 352, STT module 237 and ASR sensor 234b of input unit 130/230, and in some implementations, one or more of camera(s) 234a, FR sensor 234d and OR sensor 234e of input unit 130/230.

Referring to FIGS. 1, 3 and 4 in combination, flowchart 490 further includes identifying, using NLU model 128 and text transcription 370, segment of interest 372 of audio input 118/318, where segment of interest 372 includes feature of interest 374 (action 493). In some use cases, feature of interest 374 may be or include a first name, a surname, or a nickname of human speaker 114 or another human. Alternatively, feature of interest 374 may be or include a name of a pet, a place name such as the name of a street, city or town, country, or geographical region for example, a brand name, or a company name, to name a few additional examples. That is to say, feature of interest may include a phoneme string corresponding to a first name, a surname, a nickname, a name of a pet, a place name, a brand name, or a company name. In yet other use cases, feature of interest 374 may include one or more of a non-verbal vocalization and a non-vocal sound produced by human speaker 114, as those features are described above. Identification of segment of interest 372 including feature of interest 374, in action 493 may be performed by software code 110/310, executed by hardware processor 104 of system 100, and using segmentation block 354 and NLU model 128.

Continuing to refer to FIGS. 1, 3 and 4 in combination, flowchart 490 further includes analyzing one or more audio characteristics of feature of interest 374 (action 494). For example, where audio input 118/318 is human speech, the one or more audio characteristics of feature of interest 374 may be the prosody of feature of interest 374. As another example, where feature of interest 374 is a non-verbal vocalization or a non-vocal sound produced by human speaker 114, the one or more audio characteristics of feature of interest 374 may include the volume or time duration of feature of interest 374. Moreover, where feature of interest 374 is a first name, a surname, a nickname, a name of a pet, a place name, a brand name, or a company name, the one or more audio characteristics of feature of interest 374 may include the pronunciation of feature of interest 374 by human speaker 114. Action 495 may be performed by software code 110/310, executed by hardware processor 104 of system 100, and using analysis block 356.

Continuing to refer to FIGS. 1, 3 and 4 in combination, flowchart 490 further includes identifying, using text transcription 370, text string 376 corresponding to feature of interest 374 (action 495). Where feature of interest 374 is a first name, a surname, a nickname, a name of a pet, a place name, a brand name, or a company name, text string 376 may simply be that name spelled out. Alternatively, where feature of interest 374 is a non-verbal vocalization or a non-vocal sound produced by human speaker 114, text string 376 may be one or more words describing the sound, such as “laugh,” “sigh,” “clap” and the like. Action 495 may be performed by software code 110/310, executed by hardware processor 104 of system 100, and using alignment block 358.

Continuing to refer to FIGS. 1, 3 and 4 in combination, flowchart 490 further includes generating response 378 to audio input 118/318, response 378 including text string 376 (action 496). Response 378 may be intended to mirror a portion of audio input 118/318 by repeating a name or word spoken by human speaker 114, such as the name or home town of human speaker 114, for example. It is noted that text string 376 included in response 378 will typically be spelled correctly but may have a predetermined or default pronunciation different than its pronunciation by human speaker 114. By way of example, and further referring to FIG. 2B, human speaker 114 may identify himself by name as Herb, while text string 376 included in response 378, when later generated by TTS module 242 of output unit 140/240, may undesirably render the text string “herb” as though the text string refers to a culinary herb “erb.” Response 378 including text string 376 may be generated, in action 496, by software code 110/310, executed by hardware processor 104 of system 100, and using response generation block 360.

Continuing to refer to FIGS. 1, 3 and 4 in combination, flowchart 490 further includes modifying the response generated in action 496, using the one or more audio characteristics of the feature of interest analyzed in action 494 to produce output response 380 in which text string 376 is uttered in a characteristic voice of social agent 116a or 116b using a word pronunciation utilized by human speaker 114 in his/her speech (action 497). Output response 380 is intended to replicate the pronunciation of a name or other type of word by human speaker 114, while at the same time rendering the pronunciation in the social agent's own characteristic voice. Referring to the previous example, in which human speaker 114 identifies himself by name as Herb, while text string 376 is the string of letters herb, substitution of feature of interest 374 having specific audio characteristics for text string 376 advantageously produces output response 380 including the pronunciation of Herb specified by human speaker 114 in audio input 118/318. It is noted that in use cases in which feature of interest 374 includes a non-verbal vocalization such as a sigh, or a non-vocal sound such as a clap, output response 380 may include a sigh or clap having a time duration, volume, or both, replicating the sound produced by human speaker 114 and included in audio input 118/318.

It is further noted that output response 380 may be produced in real-time with respect to receiving audio input 118/318. As defined above, real-time in the present context refers to a time interval that enables an interaction such as a dialogue to occur without an unnatural seeming delay between a statement or question by human speaker 114 and a responsive expression by social agent 116a or 116b. By way of example, real-time may refer to a response time of on the order of one hundred milliseconds, or less. Substitution of feature of interest 374 for text string 376 in response 378 to produce output response 380, in action 497, may be performed by software code 110/310, executed by hardware processor 104 of system 100, and using response generation block 360.

In some implementations, the method outlined by flowchart 490 may conclude with action 497 described above. However, in other implementations, hardware processor 104 may further execute software code 110/310 to determine whether text string 376 includes or describes a word included on disapproved list 122 of language database 120. In use cases in which text string 376 does include or describe a word on disapproved list 122, hardware processor 104 may also execute software code 110/310 to select, based on text transcription 370, a substitute response from among multiple generic responses 124a and 124b stored in language database 120, and replace output response 380 with the substitute response, i.e., one of generic responses 124a or 124b, in real-time with respect to receiving audio input 118/318.

In some use cases, feature of interest 374 may include a speech impediment element, such as one or more repeated syllables due to stuttering by human speaker 114, or any other disfluency by human speaker 114. In those implementations, in order to avoid appearing to mock or disparagingly mimic the speech of human speaker 114, hardware processor 104 may further execute software code 110/310 to identify, using NLU model 128 and text transcription 370, the speech impediment element, and remove the speech impediment element from output response 380 to provide amended output response 382 in real-time with respect to receiving audio input 118/318.

With respect to the method outlined by flowchart 490, it is noted that the actions described by reference to that method for use by a system to render human speaker specified expressions may be performed as an automated process from which human participation other than the interaction by human speaker 114 with system 100, in FIG. 1, may be omitted.

Thus, the present application discloses interactive systems and methods rendering human speaker specified expressions that address and overcome the deficiencies in the conventional art. From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a computing platform having a hardware processor and a system memory;
the system memory storing a software code and a natural language understanding (NLU) model;
the hardware processor configured to execute the software code to:
receive an audio input, the audio input including speech by a human speaker;
produce a text transcription of the audio input;
identify, using the NLU model and the text transcription, a segment of interest of the audio input, the segment of interest including a feature of interest;
analyze one or more audio characteristics of the feature of interest;
identify, using the text transcription, a text string corresponding to the feature of interest;
generate a response to the audio input, the response including the text string; and
modify the response using the one or more audio characteristics of the feature of interest to produce an output response in which the text string is uttered in a characteristic voice of a non-human social agent using a word pronunciation utilized by the human speaker.

2. The system of claim 1, wherein the output response is produced in real-time with respect to receiving the audio input.

3. The system of claim 1, wherein the one or more audio characteristics of the feature of interest comprise a prosody of the feature of interest.

4. The system of claim 1, wherein the feature of interest is a first name, a surname, a nickname, a name of a pet, a place name, a brand name, or a company name.

5. The system of claim 1, wherein the feature of interest comprises at least one of a non-verbal vocalization or a non-vocal sound.

6. The system of claim 1, further comprising:
a language database including a disapproved list of prohibited words and a plurality of generic responses stored in the system memory, wherein the hardware processor is further configured to execute the software code to:
determine whether the text string comprises a word included on the disapproved list;
select, based on the text transcription, a substitute response from among the plurality of generic responses; and
replace the output response with the substitute response.

7. The system of claim 1, wherein the feature of interest includes a speech impediment element, and wherein the hardware processor is further configured to execute the software code to:
identify, using the NLU model and the text transcription, the speech impediment element; and
remove the speech impediment element from the output response to provide an amended output response;
wherein the amended output response is provided in real-time with respect to receiving the audio input.

8. A method for use by a system including a computing platform having a hardware processor and a system memory, the system memory storing a software code and a natural language understanding model (NLU), the method comprising:
receiving, by the software code executed by the hardware processor, an audio input, the audio input including speech by a human speaker;
producing, by the software code executed by the hardware processor, a text transcription of the audio input;
identifying, by the software code executed by the hardware processor and using the NLU model and the text transcription, a segment of interest of the audio input, the segment of interest including a feature of interest;
analyzing, by the software code executed by the hardware processor, one or more audio characteristics of the feature of interest;
identifying, by the software code executed by the hardware processor and using the text transcription, a text string corresponding to the feature of interest;
generating, by the software code executed by the hardware processor, a response to the audio input, the response including the text string; and
modifying the response, by the software code executed by the hardware processor, using the one or more audio characteristics of the feature of interest to produce an output response in which the text string is uttered in a characteristic voice of a non-human social agent using a word pronunciation utilized by the human speaker.

9. The method of claim 8, wherein the output response is produced in real-time with respect to receiving the audio input.

10. The method of claim 8, wherein the one or more audio characteristics of the feature of interest comprise a prosody of the feature of interest.

11. The method of claim 8, wherein the feature of interest is a first name, a surname, a nickname, a name of a pet, a place name, a brand name, or a company name.

12. The method of claim 8, wherein the feature of interest comprises at least one of a non-verbal vocalization or a non-vocal sound.

13. The method of claim 8, wherein the system further comprises a language database including a disapproved list of prohibited words and a plurality of generic responses stored in the system memory, the method further comprising:
determining, by the software code executed by the hardware processor, whether the text string comprises a word included on the disapproved list;
selecting, by the software code executed by the hardware processor based on the text transcription, a substitute response from among the plurality of generic responses; and
replacing, by the software code executed by the hardware processor the output response with the substitute response.

14. The method of claim 8, wherein the feature of interest includes a speech impediment element, the method further comprising:
identifying, by the software code executed by the hardware processor and using the NLU model and the text transcription, the speech impediment element; and
removing, by the software code executed by the hardware processor, the speech impediment element from the output response to provide an amended output response;
wherein the amended output response is provided in real-time with respect to receiving the audio input.

15. A computer-readable non-transitory medium having stored thereon instructions, which when executed by a hardware processor, instantiate a method comprising:
receiving an audio input, the audio input including speech by a human speaker;
producing a text transcription of the audio input;
identifying, using an NLU model and the text transcription, a segment of interest of the audio input, the segment of interest including a feature of interest;
analyzing one or more audio characteristics of the feature of interest;
identifying, using the text transcription, a text string corresponding to the feature of interest;
generating a response to the audio input, the response including the text string; and
modifying the response, using the one or more audio characteristics of the feature of interest, to produce an output response in which the text string is uttered in a characteristic voice of a non-human social agent using a word pronunciation utilized by the human speaker.

16. The computer-readable non-transitory medium of claim 15, wherein the output response is produced in real-time with respect to receiving the audio input.

17. The computer-readable non-transitory medium of claim 15, wherein the one or more audio characteristics of the feature of interest comprise a prosody of the feature of interest.

18. The computer-readable non-transitory medium of claim 15, wherein the feature of interest is a first name, a surname, a nickname, a name of a pet, a place name, a brand name, or a company name.

19. The computer-readable non-transitory medium of claim 15, the method further comprising:
determining whether the text string comprises a word included on the disapproved list;
selecting, based on the text transcription, a substitute response from among a plurality of generic responses; and
replacing the output response with the substitute response.

20. The computer-readable non-transitory medium of claim 15, wherein the feature of interest includes a speech impediment element, the method further comprising:
identifying, using the NLU model and the text transcription, the speech impediment element; and
removing the speech impediment element from the output response to provide an amended output response;
wherein the amended output response is provided in real-time with respect to receiving the audio input.
